(19) United States
(12) Patent Application Publication
(10) Pub. No.: US 2009/0237490 A1
(43) Pub. Date: Sep. 24, 2009

(54) System and method for stereoscopic image creation and transmission

(76) Inventor: Douglas V. Nelson, JR., Atlanta, GA (US)

Correspondence Address: Douglas V. Nelson Jr., 2054 Groveglen Court, Atlanta, GA, 30345, US

(21) Appl. No.: 12/053,147

(22) Filed: Mar. 21, 2008

(51) Int. Cl. H04N 13/00; H04N 13/02

(52) U.S. Cl. 348/43; 348/46; 348/42; 348/E13.001; 348/E13.074

(57) ABSTRACT

A system and method for stereoscopic image creation, transmission, and rendering includes a camera having a plurality of fixed position and orientation image capture devices in combination with a multiplexer for creating stereoscopic image data. The stereoscopic image data may be transmitted via a computer network for remote rendering and viewing, stored for subsequent transmission, and/or stored to a physical medium for distribution and/or publication. The system and method are adapted for use with currently-available personal computers and Internet connections, wherein individuals may use the system for 3-D video chat rooms, 3-D video conferencing, and 3-D video production and webcast.

### TECHNICAL FIELD

The present invention relates generally to stereoscopic imaging, and, more particularly, to a system for creation and transmission of stereoscopic video data.

### BACKGROUND OF THE INVENTION

As advances in computer and internet technology continue to improve performance and reduce costs, the personal computer and the Internet gain importance for many individuals, both in personal and professional realms. For example, Internet based communications, such as email, are gaining popularity for use in personal and business communication. Similarly, VoIP technology is increasingly replacing conventional land-based telephone service.

One important concern in any Internet based technology, from VoIP, to video conferencing, to online gaming, relates to minimum and/or optimal system requirements for the user terminal and demands on transmission or server equipment. Thus, while VoIP telecommunications systems can be run at acceptable quality levels within performance parameters of most personal computers and Internet services, the requirements for streaming video transmission at many image quality levels are significantly higher. Only recently has such streaming video technology been implemented on a widespread basis, and available to a large percentage of potential users.

Three-dimensional, or stereoscopic, imagery has been available in different formats for many years, and video implementations have been in development in recent years. The system requirements for digital stereoscopic video imaging are among the highest for video rendering, and are not yet widely available. Thus, technology in the form of systems and methods for reducing these requirements is in great demand, and is presently necessary for a wide-spread implementation of stereoscopic video imagery in entertainment and communication systems. Three-dimensional web-casts, being the logical progression resulting from the combination of Internet-based streaming video technology and digital stereoscopic video imagery, are in high demand, but also present the greatest challenge for hardware, software, and service providers due to reliance on a user's local equipment and internet service.

As such, it is clear that there is an unmet need for a system and method for stereoscopic image capture and transmission that is capable of reducing demands on a user's equipment and services. In particular, there is an unmet need for a system and method that is capable of enabling digital stereoscopic video production using widely-available personal computers and associated equipment, and that is capable of real-time Internet transmission of such stereoscopic video, such as in the form of a web-cast or video-conference.

### BRIEF SUMMARY OF THE INVENTION

Briefly described, in a preferred embodiment, the present invention overcomes the above-mentioned disadvantages and meets the recognized need for such a system and method by providing a system and method for stereoscopic image capture and transmission utilizing an integrated stereoscopic image capture device usable in combination with a personal computer that captures image data for a plurality of image plates, combines such image data into a stereoscopic video stream, and transmits such stereoscopic video stream over a computer network, such as the Internet, for real-time, or nearly real-time, viewing as a stereoscopic video.

According to its major aspects, and broadly stated, the system includes a stereoscopic image capture device in the form of a stereoscopic video camera peripheral device for use in combination with a personal computer, and the method includes acquiring image data from a plurality of image capture devices and combining the image data from at least two of the plurality of image capture devices to create stereoscopic image data.

More specifically, the stereoscopic video camera preferably includes at least two independent video capture devices disposed within a housing of the camera, wherein the relative position and alignment of each capture device is fixed or static with respect to the housing and with respect to the other capture device(s). Such relative static position and alignment preferably allows image data from each image capture device to be combined more readily into stereoscopic image data due to elimination of certain variables, such as the distance between the image capture devices, and the relative angular displacement of the focal axis of each image capture device. The housing may further carry one or more sound capture device(s) for providing audio data that may be coupled with the stereoscopic image data. The housing may further accommodate interchangeable lenses for each respective image capture device to allow for varying image formats, such as wide-angle.

Each image capture device preferably further includes unique identification information, whereby image data from each image capture device may be associated therewith, and may be characterized, such as left image data, or the like. The stereoscopic video camera may include a routing device, such as an on-board USB hub to transmit image data from each image capture device to the personal computer, or other image processing means. The personal computer preferably associates image data with a corresponding one of the plurality of image capture devices, such as based on the unique identification information associated therewith.

The system preferably further includes a computer program product in the form of computer software that is adapted to perform one or more steps of the method of creating and transmitting the stereoscopic image. Specifically, the software may associate image data acquired by each image capture device with sequencing information, such as a time stamp, for use in creating a video, for ensuring transmission of the image data in the proper sequence, and for ensuring that image data from each image capture device is combined with image data from at least one of the other image capture devices having corresponding sequence information during the creation of the stereoscopic image.

The software further preferably multiplexes image data from a plurality of the image capture devices (such as two), having corresponding sequencing information, to create stereoscopic image data. The multiplexing function preferably modifies the image data from each image capture device, whereby the stereoscopic image data is preferably reduced in size compared to the combined sizes of the captured image data. The software may preferably further process some or all of the captured image data and the stereoscopic image data, such as by performing color correction, distortion correction, alignment correction, or the like. The processing of the captured image data and/or the stereoscopic image data may be made according to predefined parameters, such as parameters generated during a camera set-up or installation process, or may be generated based on an automatic or user-defined analysis of the data.

The stereoscopic image data may then be stored, or transmitted on a real-time, or near real-time, basis for viewing. The system preferably includes client software for de-multiplexing the stereoscopic image data into distinct image plates for use in displaying the stereoscopic image to a viewer, such as through active or passive 3-D glasses, through an auto-stereoscopic display, or the like, including a multi-view auto-stereoscopic display. For stereoscopic video, the client software preferably ensures that stereoscopic image data is presented in the appropriate sequence and at the appropriate time (for correlation with corresponding audio data, for example), based on the sequencing information.

Thus, the system and method of creating stereoscopic image data may be used according to various methods for transmission and/or display of the stereoscopic image data. According to one methods the stereoscopic image data is transmitted in real-time over a computer network to a viewer, with or without a fee, in a web-cast format. In an alternate method, the stereoscopic image data is stored on a local or remote server for subsequent access by a viewer. In another alternate method, the stereoscopic image data is stored on a portable medium, such as a DVD, tape, film, or the like, for subsequent distribution and/or publication. When transmitted over a computer network, the system and method may accommodate two-way transmission of video, audio, and/or other communication data, such as text. Thus, the system and method may comprise a video-conference telephone communication over the network, or may be structured as video chat room.

Accordingly, one feature and advantage of the present invention is its ability to enable stereoscopic image creation using a standard format that may be transmitted and viewed in different formats by different users.

Another feature and advantage of the present invention is its ability to provide a network-based stereoscopic image transmission system for personal computers for use in video-conferencing and chat rooms.

Another feature and advantage of the present invention is its ability to allow streaming transmission of a stereoscopic video using low-bandwidth connections and 3-D rendering of the stereoscopic video using a personal computer.

These and other features and advantages of the present invention will become more apparent to those ordinarily skilled in the art after reading the following Detailed Description of the Invention and Claims in light of the accompanying drawing Figures.

### BRIEF DESCRIPTION OF THE DRAWINGS

Accordingly, the present invention will be understood best through consideration of, and with reference to, the following drawing Figures, viewed in conjunction with the Detailed Description of the Invention referring thereto, in which like reference numbers throughout the various Figures designate like structure, and in which:

FIG. 1 is diagram of a system according to the present invention;

FIG. 2 is a front view of a camera of the system of FIG. 1;

FIG. 3 is flowchart illustrating an exemplary method of creating stereoscopic video data;

FIG. 4 is a flowchart illustrating an exemplary method of calibrating the camera of FIG. 2;

FIG. 5 is an illustration of a graphic display of a computer program product for calibration of a stereoscopic camera;

FIG. 6 is an illustration of a graphic display of a computer program product for calibration of a stereoscopic camera;

FIG. 7 is an illustration of a graphic display of a computer program product for calibration of a stereoscopic camera;

FIG. 8 is an illustration of a graphic display of a computer program product for calibration of a stereoscopic camera;

FIG. 9 is an illustration of a graphic display of a computer program product for calibration of a stereoscopic camera;

FIG. 10 is an illustration of a graphic display of a computer program product for calibration of a stereoscopic camera;

FIG. 11 is an illustration of a graphic display of a computer program product for calibration of a stereoscopic camera;

FIG. 12 is an illustration of a graphic display of a computer program product for calibration of a stereoscopic camera;

FIG. 13 is an illustration of a graphic display of a computer program product for calibration of a stereoscopic camera;

FIG. 14 is an illustration of a graphic display of a computer program product for calibration of a stereoscopic camera;

FIG. 15 is an illustration of a graphic display of a computer program product for calibration of a stereoscopic camera;

FIG. 16 is a perspective view of the camera of FIG. 2;

FIG. 17 is a side view of the camera of FIG. 2;

FIG. 18 is a top view of the camera of FIG. 2;

FIG. 19 is a back view of the camera of FIG. 2; and

FIG. 20 is a bottom view of the camera of FIG. 2.

It is to be noted that the drawings presented are intended solely for the purpose of illustration and that they are, therefore, neither desired nor intended to limit the invention to any or all of the exact details of construction shown, except insofar as they may be deemed essential to the claimed invention.

### DETAILED DESCRIPTION OF THE INVENTION

In describing preferred embodiments of the present invention illustrated in the figures, specific terminology is employed for the sake of clarity. The invention, however, is not intended to be limited to the specific terminology so selected, and it is to be understood that each specific element includes all technical equivalents that operate in a similar manner to accomplish a similar purpose.

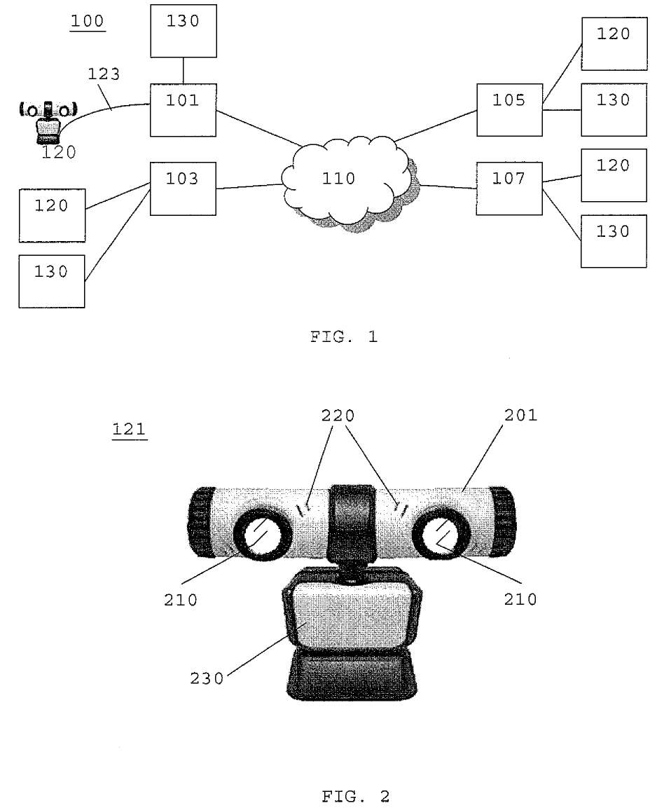

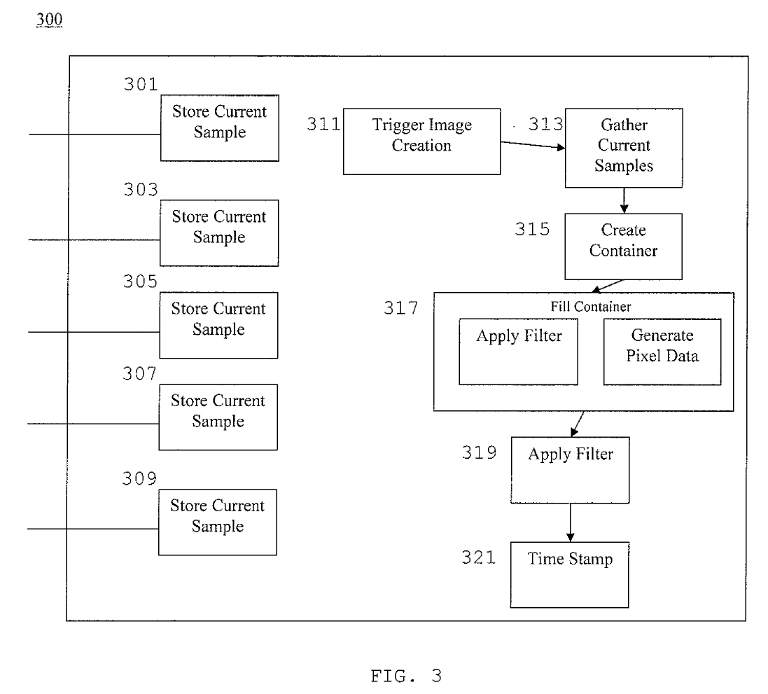

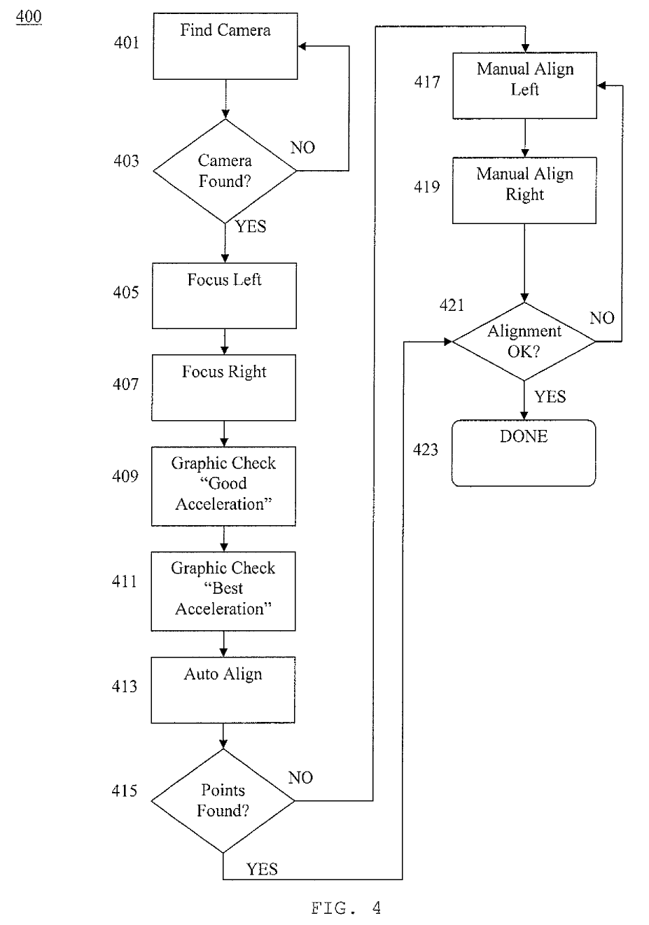

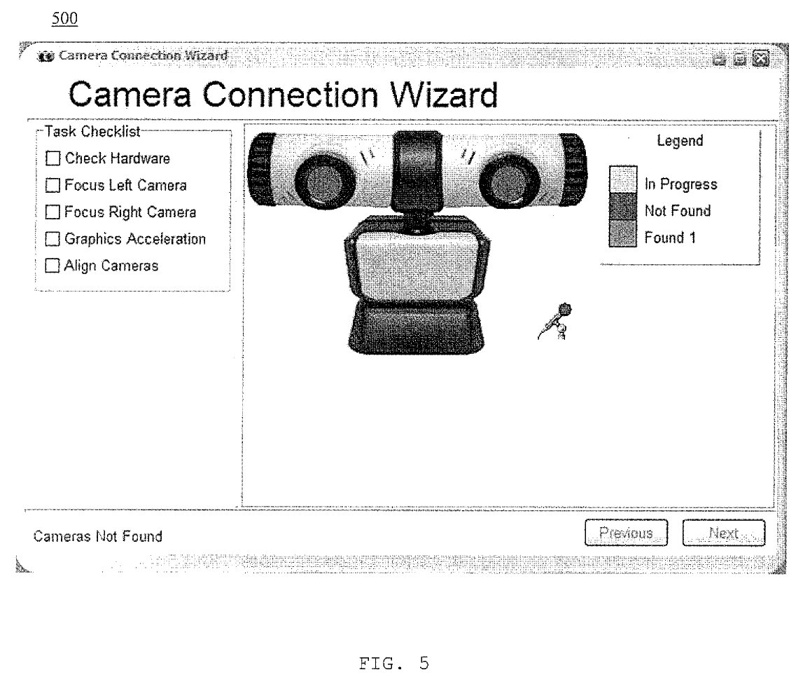

In that form of the preferred embodiment of the present invention chosen for purposes of illustration, FIGS. 1 and 2 show system 100 comprising user terminals 101, 103, 105, and 107 connected via network 110. Each of user terminals 101, 103, 105, and 107 is preferably formed as a currently-available personal computer or server computer, including input means, storage means, processing means, output means, and communications means, and/or the like. User terminal 101 is preferably associated with peripheral capture device 120 in the form of stereoscopic video camera 121 via an appropriate connector 123, such as a USB connector (IEEE 1394). Stereoscopic video camera 121 preferably includes at least two digital image capture devices 210, such as charge-coupled devices (CCDs) or complimentary metal-oxide semiconductor devices (CMOSs). Each of user terminals 101-107 is preferably associated with a respective peripheral capture device 120 in the form of a webcam, a video camera, stereoscopic video camera 121, or the like, and peripheral display device 130 in the form of a monitor or a stereoscopic display, such as an auto-stereoscopic display, active stereoscopic glasses, or the like.

Stereoscopic camera 121 preferably includes one or more microphone 220 or other audio capture device(s) and support 230. Support 230 may be formed as a base, a clip, or other free-standing or removably attachable support device. Support 230 preferably further allows case 201, and digital image capture devices 210 mounted thereon, to rotate and/or tilt as a unit relative to support 230. Case 201 preferably maintains each digital image capture device 210 in a fixed position and orientation with respect to the other digital image capture device(s) 210, including during such rotation and/or tilt.

Each of user terminals 101-107 preferably includes a computer program product operable therewith, such as in the form of a client software program. The computer program product is preferably operable to receive image data from one or more digital image capture device, to receive sound data from one or more audio capture device, to generate stereoscopic image data, to transmit stereoscopic image data, to receive stereoscopic image data, and to render stereoscopic image data on a display device. Thus, the computer program product preferably allows a user of any of user terminals 101-107 to capture, store, transmit, receive, and/or render stereoscopic image data, with or without accompanying audio data, such as in the form of a three-dimensional video. The computer program product may include additional functionality, or may be used in conjunction with additional computer program products to enable video chat, video-conferencing, or the like.

The computer program product preferably includes a multiplexer feature operable to generate stereoscopic image data for storage and/or transmission. According to exemplary method 300, the multiplexer preferably stores a current sample of image data from each of a respective one of a plurality of image capture devices, such as digital image capture devices 210, at steps 301-309. These steps are preferably repeated at a high rate such that a current sample of image data is always available. The computer program product may use RAM from a computer with which the computer program product is operable, or may use a dedicated storage medium adapted to store such current image data. The computer program product begins generation of stereoscopic image data at step 311 by triggering stereoscopic image creation. At step 313, the current samples stored in steps 301-309 are gathered from the storage medium. A container, such as a file, is then created in which the current samples will be packaged at step 315. The current samples are then added to the container at step 317, wherein the current samples of image data are filtered and stored as pixel information in the container. The container may then preferably be filtered at step 319, and a timestamp is added at step 321. The container is then ready to be stored and/or transmitted for subsequent use in rendering stereoscopic video.

The filtering at steps 317 and 319 is preferably done prior to transmission of the stereoscopic image data. The processing may be performed during the multiplexing, wherein the filtering comprises deletion of selected portions of the image data, i.e. some or all of the image data in need of correction, in order to accomplish a reduction in the size of the stereoscopic image data. Alternatively, other criteria may be used to reduce the size of the stereoscopic image data, such as deletion of pre-determined portions of the captured image data, such as image data corresponding to a background, a border, or the like.

The computer program product preferably further includes a camera calibration feature whereby a stereoscopic camera, such as stereoscopic camera 121 may be calibrated for use in generating stereoscopic image data for storage and/or transmission, such as according to the method described above. According to exemplary method 400, the computer program product begins by searching at step 401 for a stereoscopic camera (i.e. a camera having a plurality of image capture devices). At step 403, a check is performed to determine whether a stereoscopic camera is present. If no stereoscopic camera is present, then step 401 is repeated until a stereoscopic camera is found or until the process is terminated without completing calibration, such as by a user input. If a stereoscopic is found, then the left and right image capture devices are focused at steps 405 and 407. One or more rendering process(es) may then be performed and confirmation of adequate performance may be requested at steps 409 and 411. The image capture devices may then automatically be aligned at step 413. If corresponding points on image data from each of the image capture devices can be found at step 415, then verification that the alignment is acceptable may be requested at step 421. If the alignment is acceptable, the calibration process may be completed and terminate at step 423.

If, however, corresponding points cannot be found at step 415, or if the alignment is unacceptable at step 421, manual alignment of the image capture device may be performed at steps 417 and 419. Manual alignment may be accomplished by user selection of corresponding points on respective images of each image capture device, such as a furthest point shown in the images. When selection of the corresponding points is completed, verification that the alignment is acceptable is requested at step 421. The alignment step may create a filter to be applied to a current sample of image data by the multiplexer, as described above, before storing the image data in the container, whereby correction for any physical misalignment of the image capture devices of the stereoscopic camera may be enabled. Thus, a stereoscopic camera having fixed mutually-respective position and alignment of a plurality of image capture devices may be used without the need to physically adjust a position and/or orientation of any image capture device thereof.

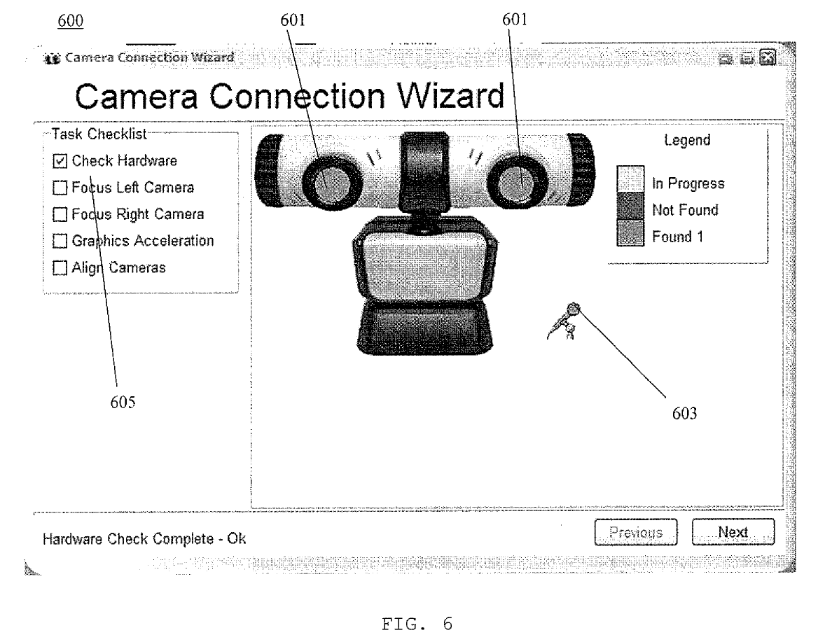

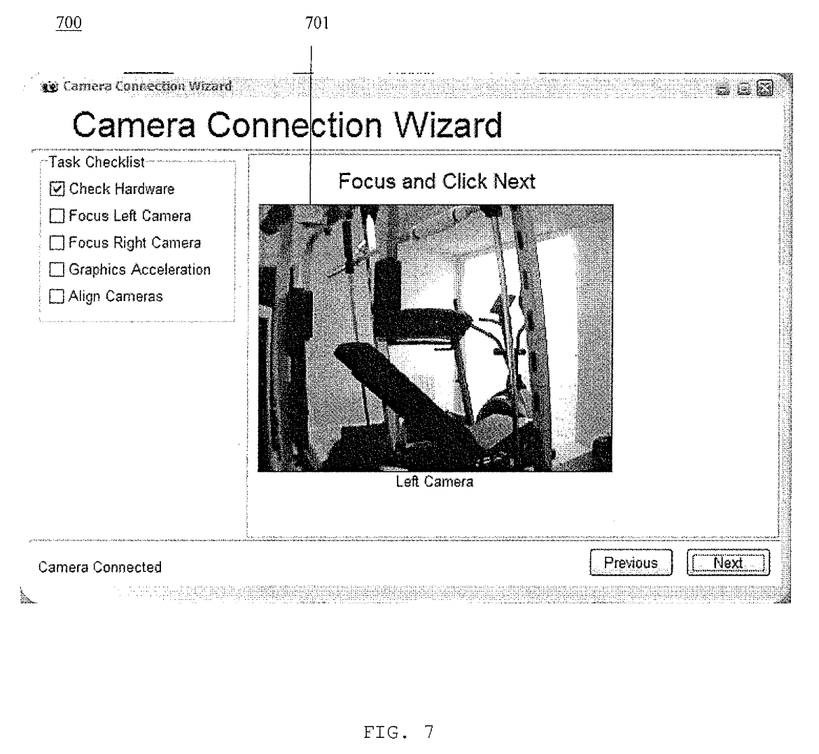

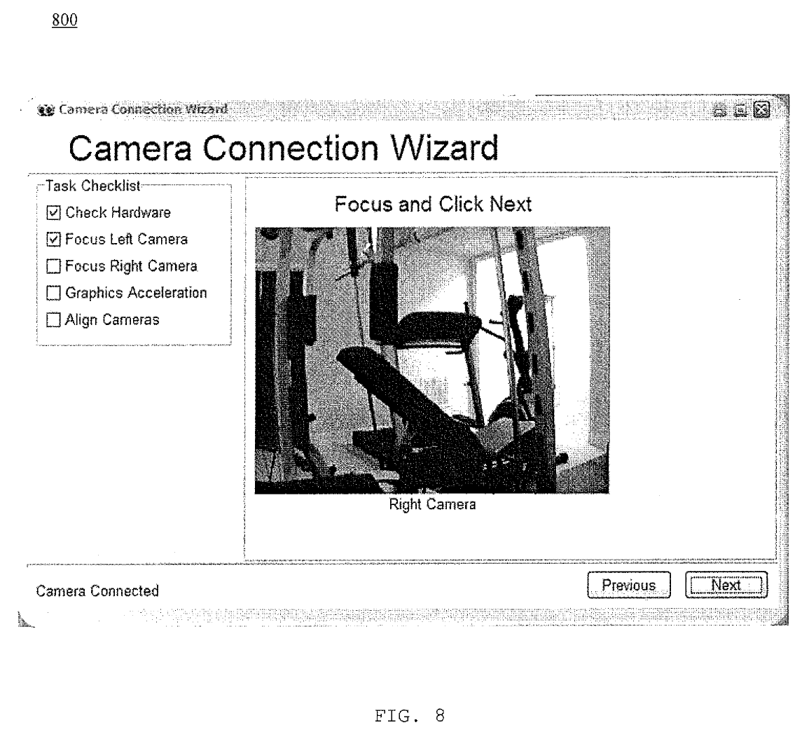

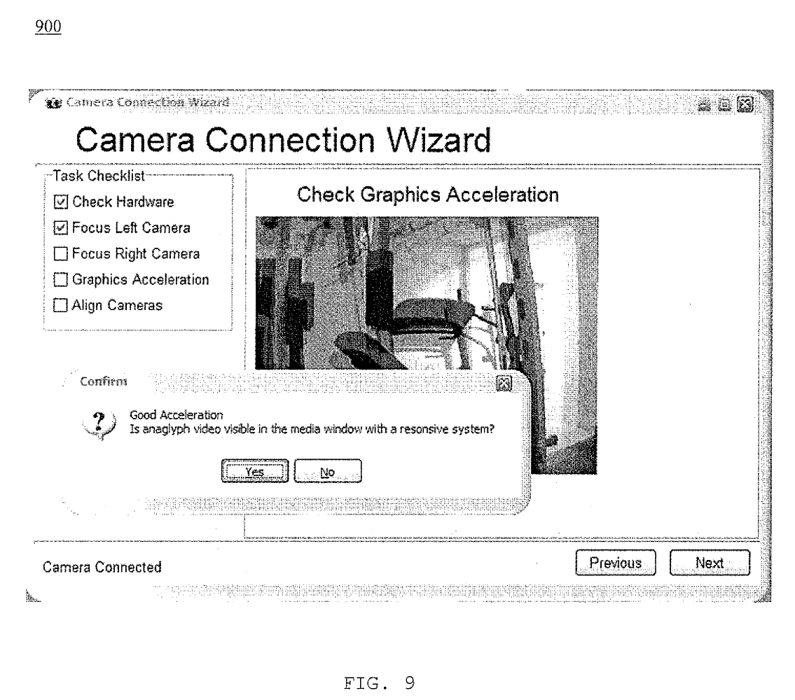

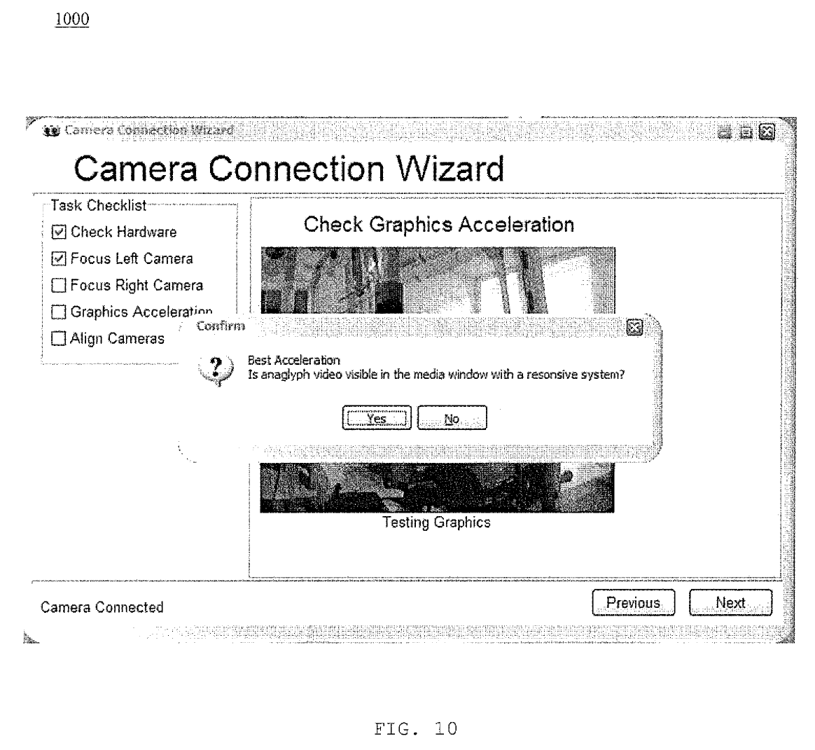

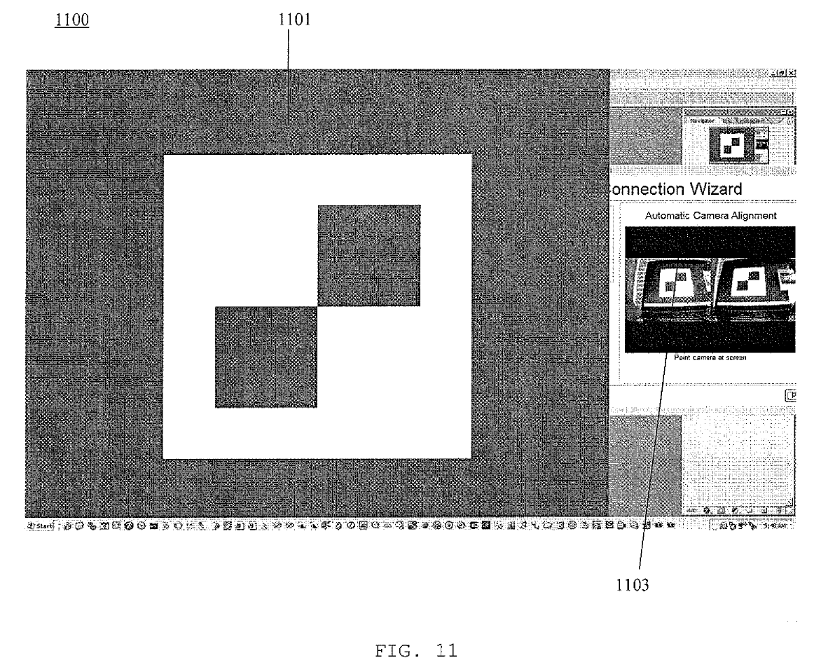

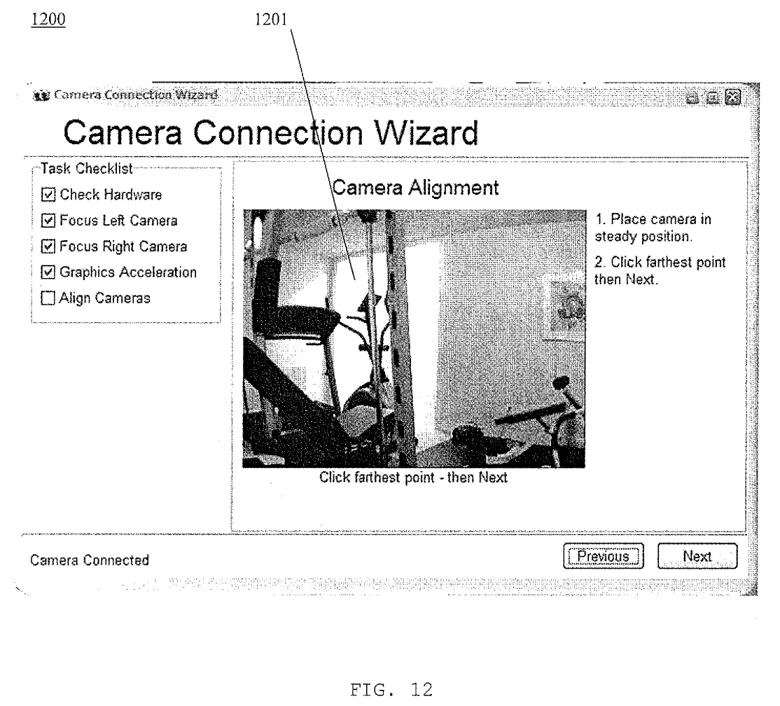

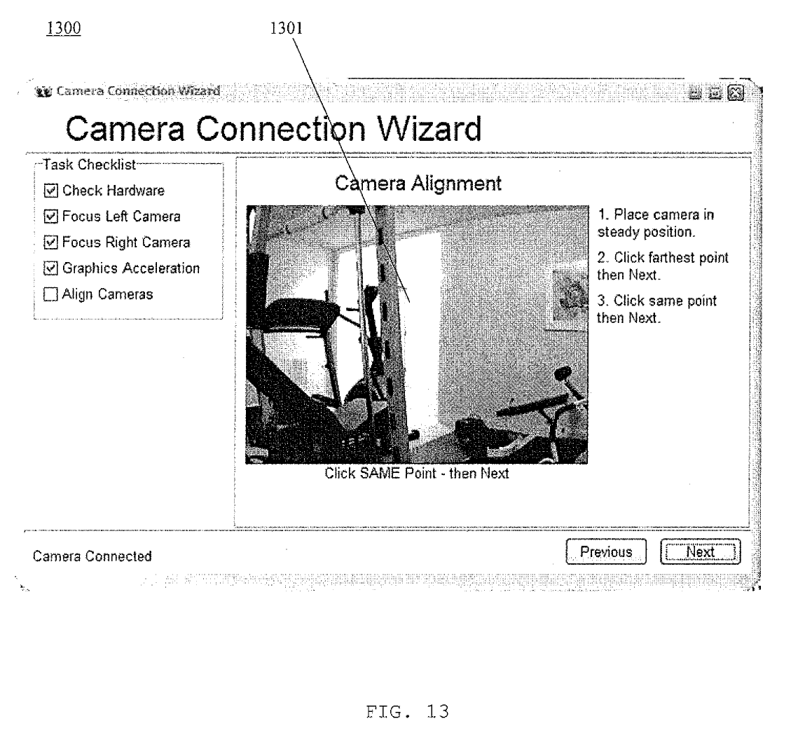

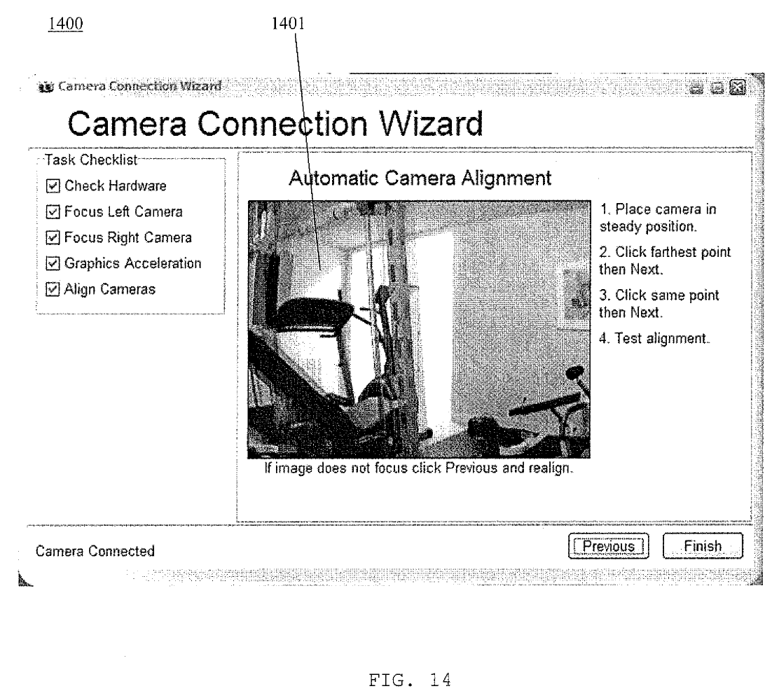

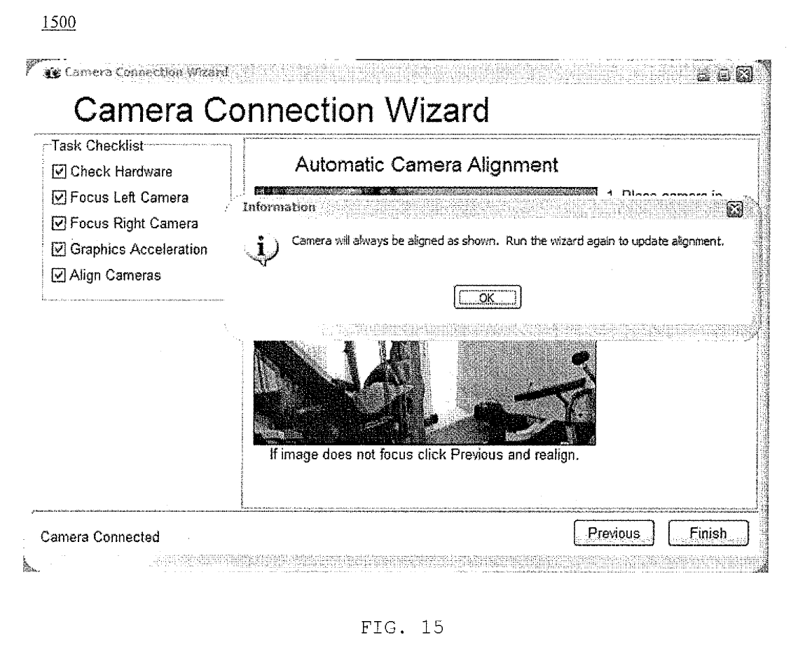

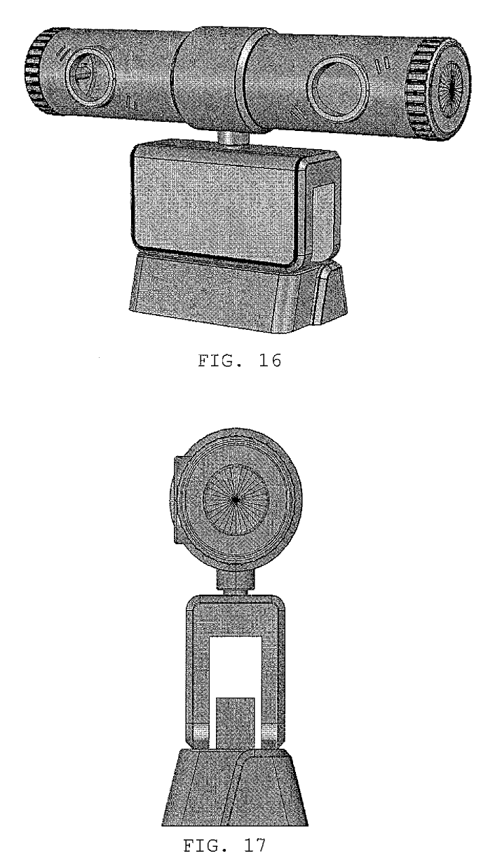

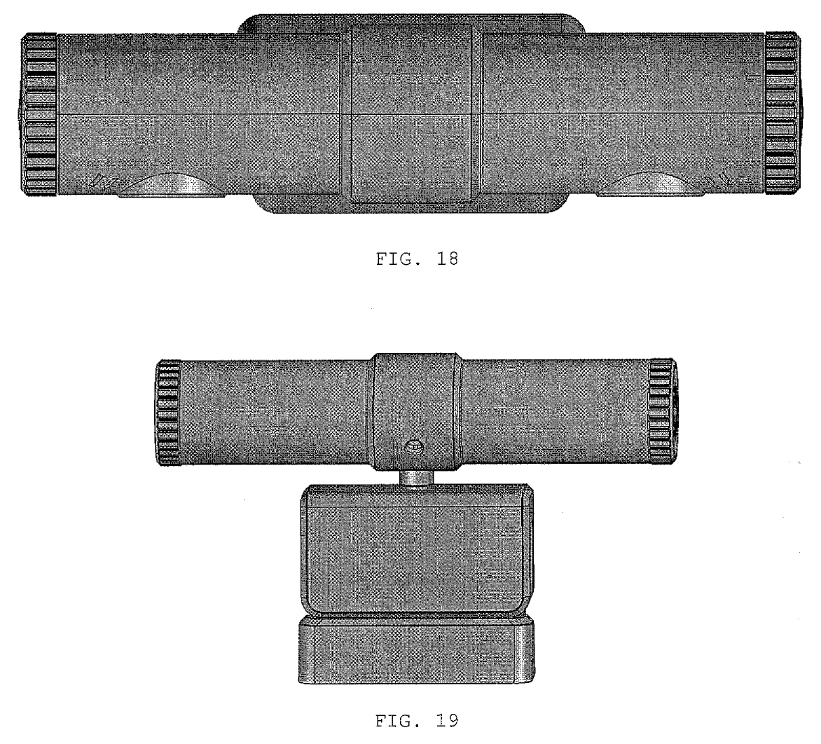

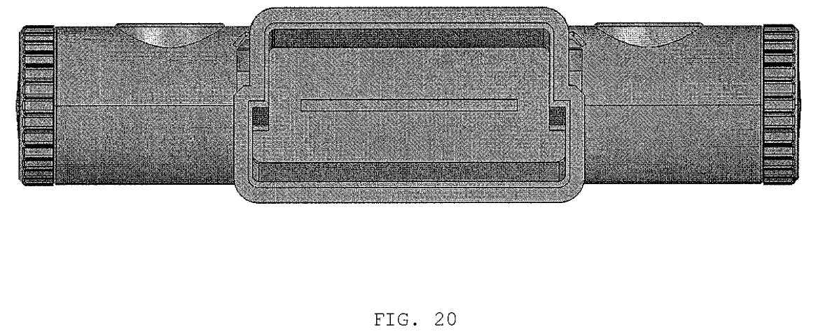

FIGS. 5-15 illustrate exemplary displays generated by the computer program product for use in carrying out method 400. Specifically, display 500 may be provided to a user via a respective one of user terminals 101-107 and peripheral display device 130 when no stereoscopic camera is detected at step 403. Alternatively, display 600 may be provided to a user when a stereoscopic camera is detected at step 403. Display 600 may include representations 601 that each of a plurality of image capture devices was found and representation 603 that an audio capture device was found. Additionally, one or more of the displays of FIGS. 5-15 may include checklist 605, whereby progress of method 400 may be displayed. Display 700 may be provided to a user including current image data associated with a selected one of the image capture devices in area 701. The image data may be used by a user to adjust a focus of the selected image capture device. As shown, a left image capture device is selected, and adjustment of the focus of the left image capture device, such as by rotation of a focus ring thereof, preferably causes the focus of the image in area 701 based on the current image data of the left image capture device to become better or worse. Display 800 shows a display for adjusting a right image capture device, and preferably operates in an analogous manner to display 700.

Display 900 may be used to test a quality of a stereoscopic image generated by the computer program product at a first performance level, such as a low or mid-level performance level. Upon completion of focusing steps 405 and 407, the computer program product may automatically generate a stereoscopic image based on current image sample data associated with respective image capture devices using a first method, such as using GDI+rendering, or the like. A user may accept or reject the stereoscopic image. Display 1000 may then be used to test a quality of a stereoscopic image generated by the computer program product at a second performance level, such as a high performance level. The computer program product may generate a stereoscopic image based on current image sample data using a second method, such as using OpenGL rendering, or the like. The user may again accept or reject the generated image.

Display 1100 may be provided by the computer program product for use in automatic alignment of a plurality of image capture devices, such as in step 413 of method 400. Display 1100 preferably includes preselected image 1101 including high contrast elements. In use, the user may position the stereoscopic camera such that preselected image 1101 is disposed in the field of view of each image capture device. Area 1103 may be provided for feedback, wherein the user may verify that preselected image 1101 is within the field of view of each image capture device. The computer program device may automatically identify one or more predetermined point(s) of preselected image 1101, such as intersections points, or other points of high contrast that may easily be identified. The computer program product may then automatically created a filter or other image editing tool for use in processing image data acquired by one or more image capture device of the stereoscopic camera. Such filter or other tool may then be used for creation of stereoscopic image data that, when rendered, creates an accurate three dimensional image.

Displays 1200 and 1300 may be used in a manual alignment process, such as that described with reference to steps 417 and 419 of method 400, above. Specifically, display 1200 may include area 1201 including an image rendered from a current sample of image data from a selected one of the image capture devices. A user may identify a point within area 1201, such as a furthest point from the stereoscopic camera, a high contrast point, or the like, as a reference point. Display 1300 may include area 1301 having an image rendered from a current sample of image data from another one of the image capture devices. The user may identify a point within area 1301 corresponding to the same point previously identified within are 1201. The computer program product may then create a filter or other image editing tool for use in processing image data acquired by one or more image capture device of the stereoscopic camera. Such filter or other tool may then be used for creation of stereoscopic image data that, when rendered, creates an accurate three dimensional image.

Display 1400 may be provided to a user including area 1401 including a stereoscopic image based on current samples of image data from two of more image capture devices, and optionally based on the filter or other tool created by the calibration process. If the image is acceptable, the user may complete the calibration process, such as via interaction with display 1500, whereafter the computer program product may create stereoscopic image data for storage and/or transmission, such as according to method 300 described above or via another suitable method. If, however, the stereoscopic image is not acceptable, the user may return to displays 1100, 1200 and/or 1300 to recalibrate the image capture devices of the stereoscopic camera.

Having thus described exemplary embodiments of the present invention, it should be noted by those ordinarily skilled in the art that the within disclosures are exemplary only and that various other alternatives, adaptations, and modifications may be made within the scope and spirit of the present invention. Accordingly, the present invention is not limited to the specific embodiments as illustrated herein, but is only limited by the following claims.

What is claimed is at least:

1. A system for creating stereoscopic image data comprising:
at least one first image capture device; and
at least one second image capture device,
wherein said at least one first image capture device and said at least one second image capture device are disposed in a camera housing, and wherein said at least one first image capture device has a fixed position and orientation with respect to a position and orientation of said at least one second image capture device.

2. The system of claim 1, further comprising a multiplexer for creating stereoscopic image data based on image data of a first image plate captured by said at least one first image capture device and image data of a second image plate captured by said at least one second image capture device.

3. The system of claim 2, wherein said multiplexer comprises a computer program product operable to gather the first image plate and the second image plate and to create stereoscopic image data in response to a trigger.

4. The system of claim 2, wherein the multiplexer is operable to process at least one of the first image plate and the second image plate.

5. The system of claim 2, wherein the multiplexer comprises a processor and a storage device disposed within said camera housing.

6. The system of claim 2, wherein said multiplexer comprises a computer operable with said first image capture device and said second image capture device.

7. The system of claim 1, further comprising an audio capture device operable with said camera housing.

8. A method of transmitting stereoscopic image data comprising the steps of:
capturing image data corresponding to a first image plate;
capturing image data corresponding to a second image plate;
combining said image data corresponding to the first image plate and said image data corresponding to the second image plate to create stereoscopic image data; and
transmitting said stereoscopic image data over a network,
wherein said stereoscopic image data is renderable in a selected one of a plurality of formats according to a display device of the recipient.

9. The method of claim 8, wherein the step of capturing image data corresponding to a first image plate is performed by a first image capture device, wherein the step of capturing image data corresponding to a second image plate is performed by a second image capture device, and wherein said first image capture device and said second image capture device are mounted in a common camera housing defining a spatial relationship between said first image capture device and said second image capture device.

10. The method of claim 9, wherein said step of combining comprises processing at least one of said image data corresponding to a first image plate and said image data corresponding to a second image plate based on said spatial relationship between said first image capture device and said second image capture device.

11. The method of claim 8, wherein said step of combining comprises assigning sequencing information to said stereoscopic image data.

12. A method of calibrating a stereoscopic camera having a plurality of image capture devices operable to output respective image data comprising the steps of:
capturing respective image data associated with at least two of the plurality of image capture devices;
creating image processing information based on respective image data associated with the at least two image capture devices; and
storing the image processing information for subsequent use in generating stereoscopic image data from respective image data of the at least two image capture devices.

13. The method of claim 12, further comprising the step of focusing at least one of the plurality of image capture devices.

14. The method of claim 12, further comprising the step of testing the image processing information.

15. The method of claim 14, wherein said step of testing comprises generating stereoscopic image data based on image data from the at least two image capture devices and the image processing information, and rendering the stereoscopic image data via a stereoscopic display.

16. The method of claim 12, wherein said step of capturing comprises generating an image on a display device, disposing the image on the display device within a common field of view of the at least two image capture devices, and capturing respective image data from the at least two image capture devices while the image is within the common field of view of the at least two image capture devices.

17. The method of claim 16, wherein said step of creating is performed by a computer according to a computer program product operable with the computer.

18. The method of claim 12, further comprising identifying at least one set of corresponding points in the respective image data, and wherein said step of creating is based on the at least one set of corresponding points.

19. The method of claim 12, wherein the at least one set of corresponding points comprises user-selected points.

20. A method of communication over a network between a first user and a second user comprising the steps of:
transmitting stereoscopic image data renderable into a stereoscopic image from the first user to the second user over the network; and
transmitting at least one of image data, audio data, and text data from the second user to the first user over the network.
